(19) United States
(12) Patent Application Publication
(10) Pub. No.: US 2025/0260919 A1
(43) Pub. Date: Aug. 14, 2025

(54) LOUDSPEAKER WITH INTEGRATED IMAGE-CAPTURING MODULE

(71) Applicant: Tymphany HK Limited, Hong Kong (HK)

(72) Inventors: Ryan Matthew Alba, Taipei City (TW); James Meredith Thompson, Taipei City (TW)

(21) Appl. No.: 19/016,527

(22) Filed: Jan. 10, 2025

Related U.S. Application Data
(60) Provisional application No. 63/551,877, filed on Feb. 9, 2024.

(51) Int. Cl. H04R 1/02; H04N 23/57; H04R 7/12

(52) U.S. Cl. CPC H04R 1/028; H04N 23/57; H04R 7/12

(57) ABSTRACT

An acoustic system (and method) for a loudspeaker includes a bottom plate; a pole-piece extending from a surface of the bottom plate. The pole-piece may include a through-bore along a central axis. A magnet at least partially surrounds. A diaphragm extends above the top surface of the pole-piece and forming a conical envelope above the top surface of the pole-piece. The diaphragm may include a central opening exposing at least a portion of the top surface of the pole-piece through a central channel. An image-capture module is disposed on the top surface of the pole-piece and extends through the central channel and at least partially into the conical envelope of the diaphragm such that at least a lens associated with a camera of the image-capture module is located within the conical envelope but outside of the central channel.

### CROSS REFERENCE TO RELATED APPLICATIONS

This application claims priority of U.S. Provisional Application No. 63/551,877 filed on Feb. 9, 2024 under 35 U.S.C. § 119(e), the entire contents of all of which are hereby incorporated by reference.

### TECHNICAL FIELD

The present application generally relates to loudspeakers, and in particular, to loudspeakers with an integrated image-capturing module.

### BACKGROUND

In addition to entertainment and recreational purposes, “content creation” or “twitch streaming” is gaining popularity as a strong tool for business analytics, freelancing and entrepreneurship, leadership and management skill development, marketing, among other things. Currently, a content creator relies on a variety of equipment for high quality audio and video capturing and processing, rendering the experience cumbersome, expensive, inefficient, and occasionally discouraging.

A content creator may benefit from tools that are portable, versatile, inexpensive, and generate high-quality audio-visual effects to highlight their work. Although high-quality audio-visual reproduction equipment may be suitable for planned events such as conferences, seminars, concerts, etc., commercially available equipment may be either expensive, or cumbersome, or both. On the other hand, while multi-functional hand-held devices such as smartphones offer portability, the audio-visual quality of recorded information may not be desirable. Additionally, it may be difficult to replace or repair hardware, e.g., camera lens, of a smartphone, rendering the device non-versatile. Therefore, it is desirable to integrate audio systems with image-capturing capabilities to enhance the user experience, while keeping costs low and generating high-quality audio and image outputs.

### SUMMARY

Embodiments consistent with the present disclosure generally describe acoustic systems for an audio-output device, and the systems include an integrated image-capturing module and methods of operating and providing the same.

Some embodiments of the present disclosure are directed to an electroacoustic transducer system for a loudspeaker. The electroacoustic transducer system may include a bottom plate and a pole-piece extending from a surface of the bottom plate. The pole-piece may include a through-bore along a central axis, and the pole-piece may have a top surface on an end of the pole-piece distally located relative to the bottom plate. The electroacoustic transducer system may further include a magnet at least partially surrounding the pole-piece and a diaphragm extending above the top surface of the pole-piece and forming a conical envelope above the top surface of the pole-piece. The diaphragm may include a central opening exposing at least a portion of the top surface of the pole-piece through a central channel. The electroacoustic transducer system may further include an image-capture module disposed on the top surface of the pole-piece and extending through the central channel and at least partially into the conical envelope of the diaphragm such that at least a lens associated with a camera of the image-capture module is located within the conical envelope but outside of the central channel.

Some embodiments of the present disclosure are directed to an acoustic system for a passive radiator. The system may include a diaphragm. The diaphragm includes a central opening extends and forms a conical envelope. The system may further include an image-capture module extending through the central opening and at least partially into the conical envelope of the diaphragm such that at least a lens associated with a camera of the image-capture module is located within the conical envelope but above of the central opening.

This invention helps integrate both a speaker and camera into a single concentric surface area, reducing total needed surface area to make the camera less noticeable and blend in with the surroundings better. It also allows better and louder sound with the bigger moving diaphragm. It can be used for a portable content creation device or IoT security devices, like the Ring or Nest doorbell cams.

### BRIEF DESCRIPTION OF DRAWING(S)

FIG. 1A illustrates a cross-section view of an exemplary electroacoustic transducer system including an image-capturing module, consistent with some embodiments of the present disclosure.

FIG. 1B illustrates a cross-section view of an exemplary passive radiator system including an image-capturing module, consistent with some embodiment of the present disclosure.

FIG. 1C illustrates a cross-section view of another embodiment of passive radiator system including an image-capturing module, consistent with some embodiment of the present disclosure.

FIG. 2A illustrates an exemplary image-capture module, consistent with some embodiments of the present disclosure.

FIG. 2B illustrates a partial cross-section view of an exemplary electroacoustic transducer system including a dust seal, consistent with some embodiments of the present disclosure.

FIG. 3 illustrated an exemplary image-capture module, consistent with some embodiment of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Some aspects of this disclosure may relate to systems and methods associated with an electroacoustic transducer system for a loudspeaker. An electroacoustic transducer, in this context, may refer to a device that converts electrical energy into acoustic energy or sound waves having a frequency typically in the range of 10 Hz to 40 KHz. In some embodiments, although not discussed herein, the electroacoustic transducer system may further comprise components and associated circuitry to convert an input acoustic signal into an electrical signal, and re-convert the electrical signal into an output acoustic signal. The output acoustic signal may comprise a modified audio signal with reference to the input acoustic signal. A loudspeaker may include a pressure generating output device used to amplify or modify an input signal using a sound transducer system such as an electroacoustic transducer system. The input signal may comprise an audio signal, an electrical signal, or a combination thereof. It is appreciated that although this application discusses a loudspeaker, other audio output devices may include but not limited to, woofers, sub-woofers, tweeter horns, etc.

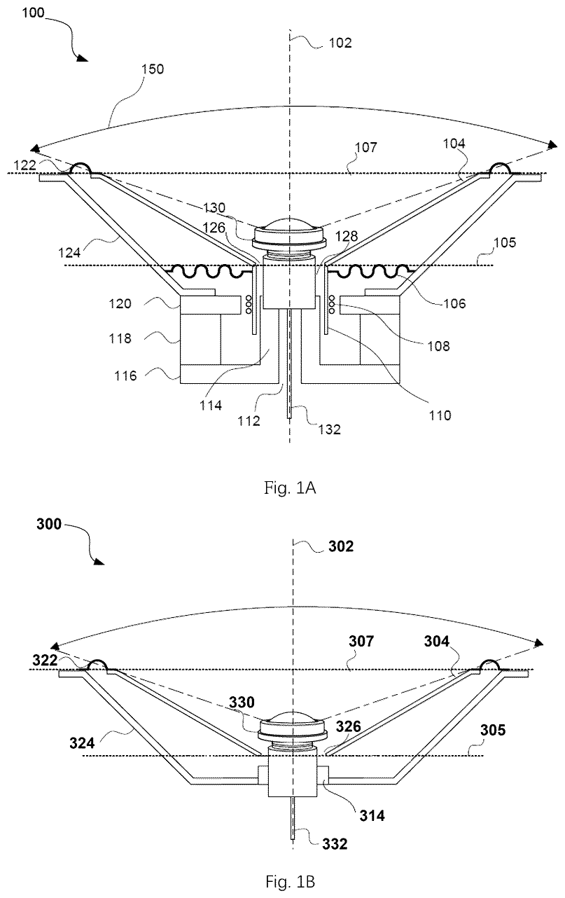

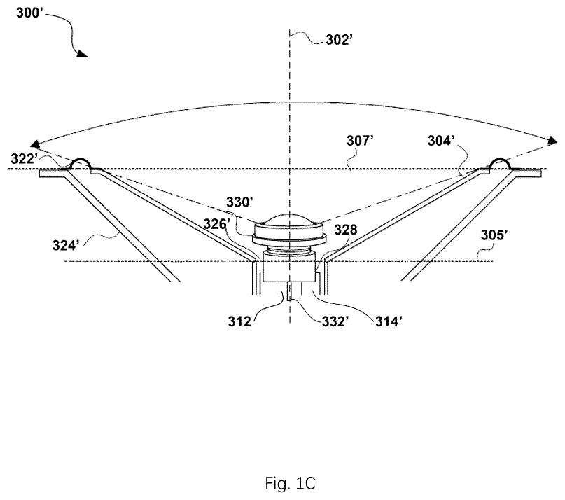

FIG. 1A illustrates an exemplary electroacoustic transducer system 100 for a dynamic moving-coil loudspeaker, consistent with disclosed embodiments. The electroacoustic transducer system 100, having a central axis 102, may comprise a diaphragm 104 comprising a central opening 126, a spider 106, a voice coil 108, a former 110, a through-bore 112 in a pole-piece 114, a bottom plate 116, a magnet 118, a top plate 120, a surround 122 connecting the diaphragm 104 with a basket 124, and an image-capture module 130. The central axis 102, shown in FIG. 1A for illustrative purposes, may represent an axis of rotational symmetry. The electroacoustic transducer system 100 may include more or fewer components, as appropriate.

The electroacoustic transducer system 100 comprises a bottom plate 116. In some embodiments, the bottom plate 116 may include a plate, a disc, a ring, or in the broadest terms, a structure configured to provide support, at least to the pole-piece 114, or to the magnet 118 (including top plate 120). The magnet 118 and top plate 120 may be substantially coaxial with the pole-piece 114. Additionally, the magnet 118 and the top plate 120 may at least partially surround the pole-piece 114. The bottom plate 116 may be made from ferromagnetic materials including, but not limited to, iron, cobalt, nickel, or alloys thereof. Alternatively, the bottom plate 116 may be made from non-magnetic metals, alloys, composites, or other materials suitable for providing structural support.

The electroacoustic transducer system 100 may further comprise a pole-piece 114 extending from a surface of bottom plate 116. In some embodiments, the pole-piece 114 may be coupled to or integrated with the bottom plate 116 such that the bottom plate 116 forms a continuous extension of the pole-piece 114. In the context of this disclosure, the term “coupled” may indicate that two or more elements can be directly coupled to one another or coupled to one another through one or more intermediate elements. The pole-piece 114 may be coupled to the bottom plate 116 such that a top surface on one end of the pole-piece 114 distally located relative to bottom plate 116 is partly exposed and the other end is coupled to the bottom plate 116. In some embodiments, the bottom plate 116 and the pole-piece 114 may form a seamless structure without any joints or discontinuities.

In some disclosed embodiments, the pole-piece 114 may include a through-bore 112 extending along the central axis 102. The through-bore 112 of the pole-piece 114 may be substantially aligned with the central axis 102. The through-bore 112 may comprise a continuous hole extending from the top surface of one end of pole-piece 114 through the bottom plate 116. The through-bore 112 may have a circular, an elliptical cross-section, a rectangular cross-section, a triangular cross-section, a non-circular cross-section, or any combination thereof. In some embodiments, the through-bore 112 may have a cylindrical shape, a conical shape, a cubical shape, or any combination thereof.

The electroacoustic transducer system 100 may comprise a diaphragm 104 extending above the top surface of the pole-piece 114 (e.g., when viewed from the side as in FIG. 1A). In some embodiments, the diaphragm 104 may form a conical envelope extending above the top surface of the pole-piece 114, as shown in FIG. 1A. The diaphragm 104 may be made from any material for use in sound reproduction applications. For example, the diaphragm may include materials comprising fabric, paper, plastic, lightweight metal, or various other materials. The diaphragm 104 may be fixedly attached to an outer surface of the basket 124 via a flexible surround 122. The diaphragm 104 may be truncated along a truncation plane to form a “truncated cone.” The truncation plane may be substantially perpendicular to the central axis 102 and may truncate a region proximal to and including the apex of the conical diaphragm 104, creating a central opening 126 in the diaphragm 104. In some embodiments, the central opening 126 may expose at least a portion of the top surface of pole-piece 114 through a central channel 128. The diaphragm 104 and central channel 128 may be coaxially arranged relative to pole-piece 114.

The electroacoustic transducer system 100 may further include a voice coil assembly comprising, e.g., a voice coil 108 wrapped around a former 110. The voice coil 108 may comprise an electrical conductor such as, for example, one or more metal wires wound around an external surface of the former 110. Electrical currents passing through the voice coil 108 produce corresponding electromagnetic fields which may interact with the magnetic field of the magnet 118 to cause controlled movement of the voice coil 108 and, therefore, the diaphragm 104 in order to reproduce sounds. The former 110 may comprise a rigid cylinder made of a material comprising, but not limited to, paper, cardboard, or the like, around which the voice coil 108 is wrapped. In some embodiments, as illustrated in FIG. 1A, the former 110 may be attached to the diaphragm 104 at the truncated end of the diaphragm 104. The spider 106 may comprise a flexible, corrugated support that secures the voice coil 108 in place while allowing the voice coil 108 to move longitudinally along the central axis 102 in response to the polarity and magnitude of electrical currents provided to the voice coil 108.

The electroacoustic transducer system 100 may further comprise an image-capture module 130 disposed on the top surface of the pole-piece 114. In some embodiments, the image-capture module 130 may be attached to the pole-piece 114 using a coupling mechanism including mechanical coupling, or thermal coupling, adhesive coupling, or any other suitable means. As shown in FIG. 1A, the image-capture module 130 may be attached to the pole-piece 114 such that at least a portion of the image-capture module 130 extends below the top surface of the pole-piece 114 in order to seat the image-capture module 130 within a recess of the top surface of the pole-piece 114. In some embodiments, the image-capture module 130 may be disposed coaxially with the pole-piece 114 and may be attached to or disposed on the top surface of the pole-piece 114 without including a recess to accept a base of the image-capture module 130.

The central channel 128 may refer to a cylindrical space or region formed within the former 110 and the truncation plane 105 of the diaphragm 104. The conical envelope of the diaphragm 104 may refer to the conical space formed between the truncation plane 105 and a base plane 107 of the diaphragm 104. As shown in FIG. 1A, the image-capture module 130 may be at least partially disposed within the central channel 128. In some embodiments, the image-capture module 130 may extend through the central channel 128 and at least partially into the conical envelope of the diaphragm 104. Protrusion of the image-capture module 130 into the conical envelope of the diaphragm 104 extending through the central channel 128 may provide a larger field-of-view to capture visual information from a wider area.

FIG. 1B illustrates an exemplary acoustic system 300 for a passive radiator, consistent with disclosed embodiments. The system 300 has a central axis 302 and may comprise a diaphragm 304 comprising a central opening 326, a surround 322 connecting the diaphragm 304 with a basket 324, a support 314 and an image-capture module 330. The central axis 302, shown in FIG. 1B for illustrative purposes, may represent an axis of rotational symmetry. The system 300 may include more or fewer components, as appropriate.

The system 300 may comprise diaphragm 304 extending above the central opening 326 (e.g., when viewed from the side as in FIG. 1B). In some embodiments, the diaphragm 304 may form a conical envelope extending above the central opening 326, as shown in FIG. 1B. The diaphragm 304 may be made from any material for use in sound reproduction applications. For example, the diaphragm may include materials comprising fabric, paper, plastic, lightweight metal, or various other materials. The diaphragm 304 may be fixedly attached to an outer surface of basket 324 via a flexible surround 322. The diaphragm 304 may be truncated along a truncation plane 305 to form a “truncated cone.” The truncation plane may be substantially perpendicular to the central axis 302 and may truncate a region proximal to and including the apex of the conical diaphragm 304, creating a central opening 326 in diaphragm 304.

The conical envelope of the diaphragm 304 may refer to the conical space formed between the truncation plane 305 and a base plane 307 of the diaphragm 304. In some embodiments, the image-capture module may extend through the central opening 326 and at least partially into the conical envelope of the diaphragm 304. A protrusion of the image-capture module 330 into the conical envelope may provide a larger field-of-view to capture visual information from a wider area.

The system 300 may further comprise the image-capture module 330 disposed on the support 314. In some embodiments, the image-capture module 330 may be attached to the support 314 using a coupling mechanism including mechanical coupling, or thermal coupling, adhesive coupling, or any other suitable means. As shown in FIG. 1B, the image-capture module 330 may be attached to the support 314 such that at least a portion of the image-capture module 330 extends below the top surface of the support 314 in order to seat the image-capture module 330 within a recess of the support 314. In some embodiments, the image-capture module 330 may be disposed coaxially with the support 314 and may be attached to or disposed on the top surface of the support 314 without including a recess to accept a base of the image-capture module 330.

FIG. 1C illustrates another exemplary acoustic system 300′ for a passive radiator, consistent with disclosed embodiments. The system 300′ has a central axis 302′ and may comprise a diaphragm 304′ comprising a central opening 326′, a through-bore 312 in a support 314′, a surround 322′ connecting the diaphragm 304′ with a basket 324′, and an image-capture module 330′. In some embodiments, the central opening 326′ may expose at least a portion of the top surface of the support 314′ through a central channel 328. The diaphragm 304′ and the central channel 328 may be coaxially arranged relative to the support 314′. The central axis 302′, shown in FIG. 1C for illustrative purposes, may represent an axis of rotational symmetry. The acoustic system 300′ may include more or fewer components, as appropriate.

In some embodiments, the diaphragm 304′ may form a conical envelope extending above the central opening 326′, as shown in FIG. 1C. The conical envelope of the diaphragm 304′ may refer to the conical space formed between a truncation plane 305′ and a base plane 307′ of the diaphragm 304′. In some embodiments, the image-capture module 330′ may extend through the central opening 326′ and at least partially into the conical envelope of the diaphragm 304′. A protrusion of the image-capture module 330′ into the conical envelope may provide a larger field-of-view to capture visual information from a wider area.

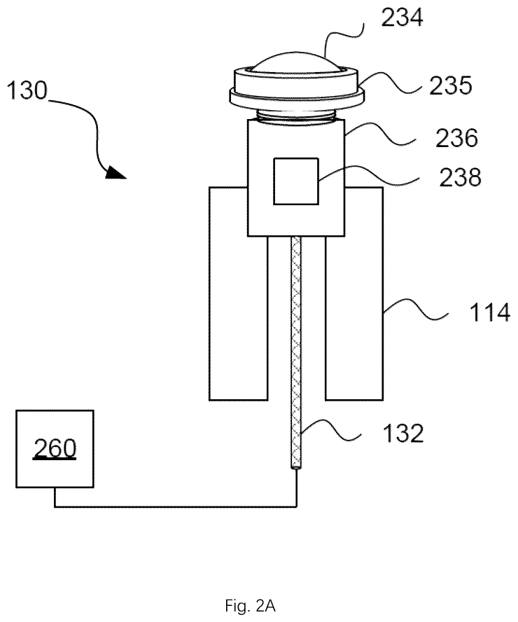

FIG. 2A provides a close-up view of image-capture module 130. The image-capture module 130 may be configured to capture still photographs, videos, or other visual information. The image-capture module 130 may comprise a lens 234 associated with a camera 235 disposed on a spacer element 236, and an electrical connector 132. The lens 234 may be disposed on a top surface of the camera 235 distal from the spacer element 236. In some disclosed embodiments, the image-capture module 130 may be disposed on a top surface of the pole-piece 114 (as shown in FIG. 1A) such that at least the lens 234 associated with the camera 235 is located within the conical envelope but outside the central channel 128. In some embodiments, the camera 235 may be positioned along the central axis 102 such that the camera 235 associated with the image-capture module 130 resides fully within the conical envelope.

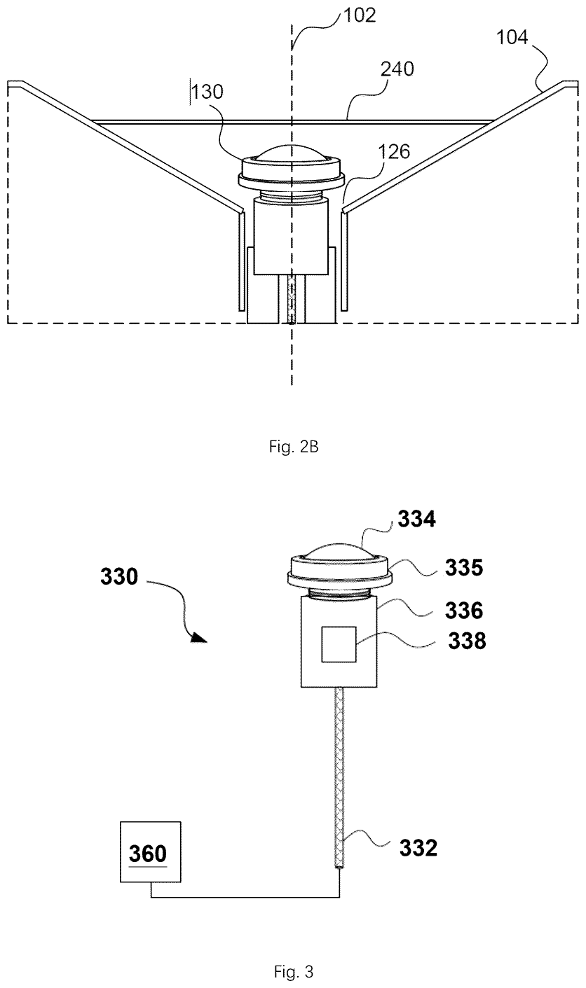

FIG. 3 provides a close-up view of image-capture module 330. The image-capture module 330 may be configured to capture still photographs, videos, or other visual information. The image-capture module 330 may comprise a lens 334 associated with a camera 335 disposed on a spacer element 336, and an electrical connector 332. The lens 334 may be disposed on a top surface of the camera 335 distal from the spacer element 336. In some disclosed embodiments, the image-capture module 330 may be disposed on the support 314 such that at least the lens 334 associated with the camera 335 is located within the conical envelope but outside the central opening 326. In some embodiments, the camera 335 may be positioned along the central axis 302 such that the camera 335 associated with the image-capture module 330 resides fully within the conical envelope.

The field-of-view (FOV) associated with a camera (e.g., camera 235) refers to the maximum area that the camera can image, and may be determined based on the focal length of the lens and the size of the sensor. Angular field-of-view (AFOV) refers to the angle between any light captured at the optical axis, and any light captured at the edge of the lens. For a fixed sensor size, increasing the focal length of the lens may reduce the AFOV, and reducing the focal length of the lens may increase the AFOV, and therefore increase the FOV as well.

In some disclosed embodiments, an angular field of view 150 (shown in FIG. 1A) associated with camera 235 may be greater than an angle associated with a vertex of the conical envelope of diaphragm 104. Positioning the camera 235 on the spacer element 236 such that either the lens 234 or the camera 235 including the lens 234 is located fully within the conical envelope and protruding from the central channel 128 may offer several potential advantages. For example, the angular field-of-view (AFOV) associated with the camera 235 comprising the lens 234 protruding above the truncation plane into the conical envelope of the diaphragm 104 may be larger in comparison to the AFOV associated with a camera lens located below the truncation plane. Such a configuration may allow a user to capture images representative of larger areas of an environment relative to cameras with more limited AFOVs. In some embodiments, the angular field-of-view associated with the camera 235 is at least 90°. In some embodiments, the angular field-of-view associated with the camera 235 is at least 135°.

In the context of this disclosure, the term “resolution” of a camera indicates pixel resolution, considered equivalent to pixel count within a specified area of an image. For example, an image comprising 2048 pixels in width and 1536 pixels in height has a total of 3,145,728 pixels or 3.1 megapixels. In some embodiments, the camera 235 may have a resolution of at least 1.3 megapixels. It will be appreciated that the pixel resolution of a camera may be determined by the number of pixels available in an image sensor and that higher pixel resolution may result in better image quality.

The image-capture module 130 may comprise the spacer element 236 configured to connect the camera 235 with the top surface of the pole piece 114. In some embodiments, one end of the spacer element 236 may be attached to camera 235, and the other end may be attached to the pole-piece 114, forming a connection between the camera 235 and the pole-piece 114, as illustrated in FIG. 2. In some embodiments, the camera 235 may be removably attached to the spacer element 236 through an attachment mechanism such as a mechanical coupling, for example. Such an attachment mechanism may offer several advantages. For example, the attachment mechanism may allow a user to easily and quickly replace a camera-lens assembly based on a desired output or application. A top end of the spacer element 236 may be configured to receive and/or releasably secure the camera 235, and a bottom end may be configured to attach to the pole-piece 114 (e.g., fixedly or releasably).

In some embodiments, the length of the spacer element 236 may be adjustable to enable selective positioning of the camera 235 along the central axis 102. In some disclosed embodiments, the spacer element 236 may have a length greater than a depth of the central channel 128. The length of the spacer element 236 may be adjustable, at least based on a desired AFOV. As an example, for a given camera-lens assembly, a longer spacer element 236 may protrude farther into the conical envelope of the diaphragm 104, thus providing a larger AFOV compared to a shorter spacer element 236. In some embodiments, the position of the spacer element 236 may be adjustable to adjust the position of the camera 235 attached to the spacer element 236, thereby adjusting the AFOV of the camera 235.

The length of the spacer element 236 may be extendable along the central axis 102. In some embodiments, a minimum contracted length of the spacer element 236 may be substantially equal to or greater than the depth of the central channel 128. Alternatively, in some embodiments, the minimum contracted length may be less than the depth of the central channel 128, but the fully extended length may be greater than the depth of the central channel 128.

The image-capture module 130 may further include control circuitry 238 configured to control operation of the camera 235. The control circuitry 238 may comprise one or more electronic circuit components including, but not limited to, resistors, capacitors, inductors, power source, power management components, timers, or the like. Controlling operation of the camera 235 may include, for example, activation and deactivation of the camera 235 by managing power supply. The control circuitry 238 may be configured to perform other suitable functions as well. In some embodiments, the control circuitry may comprise an integrated circuit, a microprocessor, a processor, a data storage mechanism, a data transfer mechanism, or other relevant components.

In some disclosed embodiments, the spacer element 236 may be placed coaxially relative to the pole-piece 114. The spacer element 236 may be cylindrical, cubical, conical, or other shape. In some embodiments, the spacer element 236 and the the pole-piece 114 are cylindrical, and the bottom end of the spacer element 236 has one of male threads and female threads, and the top end of the pole-piece 114 has a cylindrical cavity having the other of the male threads and the female threads corresponding to one of the male threads and the female threads of the spacer element 236. That is, if the bottom end of the spacer element 236 has the male threads, the cavity of the pole-piece 114 has the female threads; if the bottom end of the spacer element 236 has the female threads, the cavity of the pole-piece 114 has the male threads. The radius of the cavity is greater than the radius of the spacer element 236 so that the spacer element 236 can be placed in the cavity and be fixed by the threads. In some embodiments, the spacer element 236 and the pole-piece 114 are cylindrical, and the bottom end of the spacer element 236 has a cylindrical cavity having one of male threads and female threads and the top end of the pole-piece 114 has the other of the male threads and the female threads corresponding the threads of the cavity of the spacer element 236. That is, if the cavity of the spacer element 236 has the male threads, the pole-piece 114 has the female threads; if the cavity of the spacer element 236 has the female threads, the pole-piece 114 has the male threads. The radius of the cavity is greater than the radius of the area of the top end of the pole-piece 114 so that the top end of the pole-piece 114 can protrude into the cavity and be fixed by the threads. In some embodiments, the control circuitry 238 may be housed within the spacer element 236. The control circuitry 238 may be located outside the spacer element 236 but within the electroacoustic transducer system 100, or at a remote location.

The image-capture module 130 may further comprise an electrical connector 132. In some cases, the electrical connector 132 may provide power to the image-capture module 130 and/or to one or more components of the control circuitry 238. The electrical connector 132 may also be configured to enable communication between an external controller 260 and the control circuitry 238 housed within the spacer element 236. Some examples of communication between the external controller 260 and the control circuitry 238 may include, but are not limited to, shutter release signals, switching in and out of power-save mode, auto-focus, feature identification, etc. Alternatively, in some embodiments, the electrical connector 132 may be part of the electroacoustic transducer system 100. The electrical connector 132 may comprise one or more of a power cable, a signal cable, a data transfer cable, or an electronic communication cable suitable for transferring power and/or electrical signals between the external controller 260 and/or various power sources and the control circuitry 238 and/or the components of the image-capture module 130. The spacer element 236 may include a central opening in the bottom surface configured to allow passage of the electrical connector 132 therethrough. In some embodiments, the opening may be coaxial with the pole-piece 114. In some embodiments, at least a portion of electrical connector 132 is disposed within the through-bore 112 of the pole-piece 114, as illustrated in FIGS. 1A and 2A.

The external controller 260 may comprise a computer, a processor, a microprocessor, an integrated circuit, or circuitry configured to communicate with the control circuitry 238. In some embodiments, the external controller 260 may be associated with a graphic user interface (GUI) such as an interactive display, touch screen, input-output apparatus, or other means of interaction between a user and the electroacoustic transducer system 100. The external controller 260 may further comprise a data storage mechanism including, but not limited to, a database, a server, or a memory, configured to receive, store, or process data from the image-capture module 130, for example. In some embodiments, the external controller 260 may be remotely controlled using a wireless communication means.

By way of example, a user may provide an input command, remotely, using the GUI interface of the external controller 260, the input command instructing the control circuitry 238 to activate the camera 235 by supplying power through an activation circuit. In another example, the user may want to capture some visual information in the field-of-view of the camera 235. In such a case, the user may provide an appropriate command to the external controller 260 to instruct the control circuitry 238 to initiate capturing of an image or a sequence of images in a video format. In some embodiments, the captured information may be transferred from a temporary data storage medium of the control circuitry 238 to a data storage component of the external controller 260 using the electrical connector 132 (e.g., a data cable).

In some disclosed embodiments, as shown in FIG. 3, the image-capture module 330 may further include a control circuitry 338 configured to control operation of the camera 335. The control circuitry 338 may comprise one or more electronic circuit components including, but not limited to, resistors, capacitors, inductors, power source, power management components, timers, or the like. Controlling operation of the camera 335 may include, for example, activation and deactivation of the camera 335 by a managing power supply. The control circuitry 338 may be configured to perform other suitable functions as well. In some embodiments, the control circuitry may comprise an integrated circuit, a microprocessor, a processor, a data storage mechanism, a data transfer mechanism, or other relevant components.

The image-capture module 330 may further comprise an electrical connector 332. In some cases, the electrical connector 332 may provide power to the image-capture module 330 and/or to one or more components of the control circuitry 338. The electrical connector 332 may also be configured to enable communication between an external controller 360 and the control circuitry 338 housed within the spacer element 336. Some examples of communication between the external controller 360 and the control circuitry 338 may include, but are not limited to, shutter release signals, switching in and out of power-save mode, auto-focus, feature identification, etc. The electrical connector 332 may comprise one or more of a power cable, a signal cable, a data transfer cable, or an electronic communication cable suitable for transferring power and/or electrical signals between the external controller 360 and/or various power sources and the control circuitry 338 and/or components of the image-capture module 330. The spacer element 336 may include a central opening in the bottom surface configured to allow passage of the electrical connector 332 therethrough.

The external controller 360 may comprise a computer, a processor, a microprocessor, an integrated circuit, or circuitry configured to communicate with control circuitry 338. In some embodiments, the external controller 260 may be associated with a graphic user interface (GUI) such as an interactive display, touch screen, input-output apparatus, or other means of interaction between a user and the acoustic system 300. The external controller 360 may further comprise a data storage mechanism including, but not limited to, a database, a server, or a memory, configured to receive, store, or process data from the image-capture module 330, for example. In some embodiments, the external controller 360 may be remotely controlled using a wireless communication means.

In some disclosed embodiments, the electroacoustic transducer system 100 may further include a dust seal 240 configured to impede particulate entry into the central channel 128, as shown in FIG. 2B. Entry of dust particles, debris, particulates, or the like into the central channel 128 may hinder the movement of the voice coil 108 along the central axis 102, thereby causing variation in tonal characteristics of output audio signals, and resultantly deterioration of sound quality. The dust seal 240 may be configured to minimize the occurrence of sound quality deterioration by impeding entry of undesirable particulates into the central channel 128. The dust seal 240 may comprise a mesh, a screen, a filter, a paper, or any other material appropriate for preventing dust particles from falling into the central channel 128. The dust seal 240 may comprise at least one transparent dust cover such that the dust seal 240 may not block or absorb light to be captured by the camera 235. In some embodiments, the dust seal 240 may be radially fastened to an inner surface of the diaphragm 104. Although the dust seal 240 is shown as being disposed substantially perpendicular to the central axis 102, a person of ordinary skill in the art would appreciate that other profiles of the dust seal 240 such as, for example, dome, semi-dome, conical, may be used, making the radius as small as possible without interfering with the camera module.

What is claimed is:

1. An acoustic system, comprising:
a support having a top surface and a through-bore along a central axis of the support;
a diaphragm extending and forming a conical envelop, and including a central opening; and
an image-capture module, including a camera having a lens, disposed on the top surface of the support and extending through the central opening and at least partially into the conical envelope of the diaphragm such that at least the lens is located within and above the conical envelope.

2. The system of claim 1, wherein the camera of the image-capture module resides fully within the conical envelope formed by the diaphragm.

3. The system of claim 1, wherein an angular field of view associated with the camera is greater than an angle associated with a vertex of the conical envelope, and
wherein the camera has a resolution of at least 1.3 megapixels.

4. The system of claim 3, wherein the angular field of view associated with the camera is at least 90°.

5. The system of claim 3, wherein the angular field of view associated with the camera is at least 135°.

6. The system of claim 1, wherein the image-capture module further comprises:
a control circuitry configured to control operation of the camera; and
a spacer element configured to connect the camera with the top surface of the support.

7. The system of claim 6, wherein the control circuitry is housed within the spacer element connecting the image-capture module to the top surface of the support.

8. The system of claim 7, further comprising an electrical connector configured to enable communication between an external controller and the control circuitry.

9. The system of claim 8, wherein the electrical connector comprises one or more of a power cable, a signal cable, a data transfer cable, or an electronic communication cable.

10. The system of claim 8, wherein at least a portion of the electrical connector is disposed within the through-bore of the support.

11. The system of claim 7, wherein the camera is removably attached to the spacer element.

12. The system of claim 1, further comprising one or more dust seals configured to impede particulate entry into the central opening.

13. The system of claim 12, wherein the one or more dust seals are radially fastened to an inner surface of the diaphragm.

14. The system of claim 12, wherein the one or more dust seals comprise at least one transparent dust cover.

15. The system of claim 1 further comprising:
a bottom plate; and
a magnet,
wherein the support is a pole piece extending from a surface of the bottom plate, the magnet at least partially surrounds the pole-piece, the pole-piece has a top surface on an end of the pole-piece distally located relative to the bottom plate, and
wherein the central opening of the diaphragm exposes at least a portion of the top surface of the pole-piece through a central channel.

16. The system of claim 15, wherein the spacer element and the pole-piece are cylindrical, the bottom end of the spacer element has one of male threads and female threads, the top end of the pole-piece has a cylindrical cavity having the other of the male threads and the female threads corresponding to one of the male threads and the female threads of the spacer element, and
wherein a radius of the cavity is greater than a radius of the spacer element so that the spacer element can be placed in the cavity and be fixed by the threads.

17. The system of claim 15, wherein the spacer element and the pole-piece are cylindrical, the bottom end of the spacer element has a cylindrical cavity having one of male threads and female threads, the top end of the pole-piece has the other of the male threads and the female threads corresponding to one of the male threads and the female threads of the spacer element, and
wherein a radius of the cavity is greater than a radius of an area of the top end of the pole-piece so that the top end of the pole-piece can protrude into the cavity and be fixed by the threads.

18. The system of claim 15, wherein the spacer element has a length greater than a depth of the central channel.
